(19) United States
(12) Patent Application Publication
(10) Pub. No.: US 2015/0355352 A1
(43) Pub. Date: Dec. 10, 2015

(54) Industrial Sensor System and Method of Use

(71) Applicant: VTB Net, Inc., Houston, TX (US)

(72) Inventors: Quentin Bach, Houston, TX (US); Oguz Murtezaoglu, Houston, TX (US)

(73) Assignees: BIPOM ELECTRONICS, INC., Houston, TX (US); VTB NET, Inc, Houston, TX (US)

(21) Appl. No.: 14/364,044

(22) PCT Filed: Dec. 10, 2012
(86) PCT No.: PCT/US12/68837

§ 371 Date: Jun. 9, 2014

Related U.S. Application Data
(60) Provisional application No. 61/568,648, filed on Dec. 8, 2011.

(51) Int. Cl. G01V 1/16

(52) U.S. Cl. CPC G01V 1/164

(57) ABSTRACT

An industrial sensor system is disclosed. Said system comprising a communication module, a one or more sensors, and a power system. Said one or more sensors having a body and a logic board. Said one or more signals generated by said logic boards of said one or more sensors. Said logic board of said one or more sensors having a microcontroller capable of processing said one or more signals and a communication BUS capable of communicating with said communication module and other among said one or more sensors over a network.

### CROSS-REFERENCE TO RELATED APPLICATIONS

This application claims reference to PCT application PCT/US12/68837 (filed 2012-12-08) which, in turn, claims benefit of U.S. provisional application 61/568,648 (filed 2011 Dec. 8). This application if filed on Monday, Jun. 9, 2014, which is on the first Monday following the 30^{th} month after the provisional application was filed. Accordingly, this application properly and timely claims benefit to the original filing date of the provisional application and the term of the PCT applications cited above.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

This disclosure relates generally to an industrial sensor system and method of use. Systems and methods for vibration sensing lack the benefits of the system and method herein disclosed. As such, since none of the current systems, taken either singularly or in combination are seen to describe the instant disclosure. Accordingly, an improved industrial sensor system and method of use would be advantageous.

### BRIEF SUMMARY OF THE INVENTION

An industrial sensor system is disclosed. Said system comprising a communication module, a one or more sensors, and a power system. Said one or more sensors having a body and a logic board. Said one or more signals generated by said logic boards of said one or more sensors. Said logic board of said one or more sensors having a microcontroller capable of processing said one or more signals and a communication BUS capable of communicating with said communication module and other among said one or more sensors over a network.

The following comments are directed toward the prior art references presented in the international search report (the “ISR”) of the parent application (PCT/US12/68837). Note that the claims of this application are narrower than the set of claims in the PCT application. Here, the limitations of claims 1, 3, 5, and 7-8 of the PCT application are all included in the currently presented independent claim 1. Accordingly, it is respectfully requested that examination be directed at the narrowed apparatus.

The ISR —primary citing prior art references Wallauer (2010/0308811) and Arms (U.S. Pat. No. 6,462,554 B2)—states that the original claims do not meet the inventive step requirement.

Here, claim 1 is distinguished from Wallauer, in that Wallauer uses magnetic flux in his sensor configuration, whereas claim 1 uses seismic sensors capable of measuring amplitude of vibrations. This is a distinction with a substantial innovation. The device described in claim 1 is adapted to sensing vibrations in machines which are prone to failure and damage if not properly monitored, the use of several types of seismic sensors is an innovation in this context. Consider, Wallauer is used to do magnetic signal analysis, which is a different field. In our case, the use of different sensor types (digital and analog) and calculating a true signal represent a breakthrough in the Applicants' industries.

Further, claim 1 includes limitations drawn to the types of sensors being used. In order to calculate the true signal use of sensors capable of sensing acceleration at low frequencies is just as important as sensing vibrations at high frequencies.

### BRIEF DESCRIPTION OF THE SEVERAL VIEWS OF THE DRAWING

FIGS. 1A, 1B, 1C, 1D, 1E and 1F illustrate a first and second side perspective overview, a second side elevated view, a front side elevated view, a first side elevated view, and a top elevated view of a sensor system.

FIGS. 2A, 2B and 2C illustrate a perspective cross-section over view of said sensor system without a logic board, with said logic board outside of said cavity and inside of said cavity.

FIG. 3 illustrates a flow diagram of said plurality of components within said sensor system.

FIG. 4A illustrates a first network diagram of a plurality of said sensor systems.

FIG. 4B illustrates a second network diagram of said plurality of said sensor systems.

FIG. 4C illustrates a third network diagram of said plurality of said sensor systems.

FIG. 5 illustrates a flow diagram of said plurality of components within said communication module.

### DETAILED DESCRIPTION OF THE INVENTION

Described herein is an industrial sensor system and method of use. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

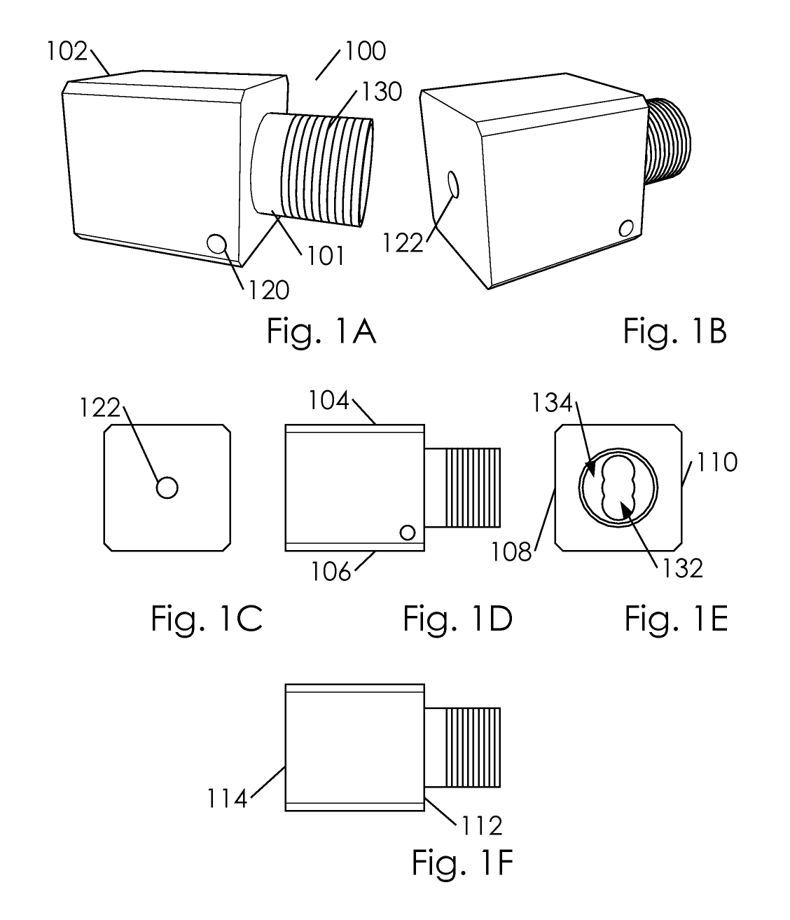

FIGS. 1A, 1B, 1C, 1D, 1E and 1F illustrate a first and second side perspective overview, a second side elevated view, a front side elevated view, a first side elevated view, and a top elevated view of a sensor system 100. In one embodiment, sensor system 100 can comprise a NPT portion 101, a body 102, a top 104, a bottom 106, a front 108, a back 110, a first side 112 and a second side 114. In one embodiment, said body 102 can comprise a first aperture 120 and a second aperture 122. In one embodiment, said first aperture 120 can cut through said body 102 from said front 108 to said back 110. In one embodiment, said second aperture 122 can cut into a portion of said second side 114 of said body 102. In one embodiment, said second aperture 122 can be used to attach said sensor system 100 to a stud mount. In one embodiment, said first aperture 120 and/or said second aperture 122 can be used to attach said sensor system 100 to an object for monitoring (as discussed below).

In one embodiment, said body 102 can comprise a substantially rectangular shape where said top 104, said bottom 106, front 108, said back 110, said first side 112 and said second side 114 can be substantially flat. In one embodiment, said sensor system 100 can be injection molded, or built in other well-known manufacturing means. In one embodiment, said NPT portion 101 can comprise a cylindrical portion of said sensor system 100 comprising an external threading 130. In one embodiment, said NPT portion 101 can be substantially hollow. In one embodiment, said sensor system 100 can comprise a cavity 132. In one embodiment, said cavity 132 can be in said body 102. In one embodiment, said cavity 132 can be accessible through an open end 134 of said NPT portion 101.

In one embodiment, said communications port 101 can protrude from said first side 112. In one embodiment, said first side 112 can comprise a data communications port capable of receiving a cable to data communications with other devices.

In one embodiment, sensor system 100 can comprise a Piezo ceramic element.

In one embodiment, communications port 101 can comprise a T-Port Connector to maintain digital life integrity.

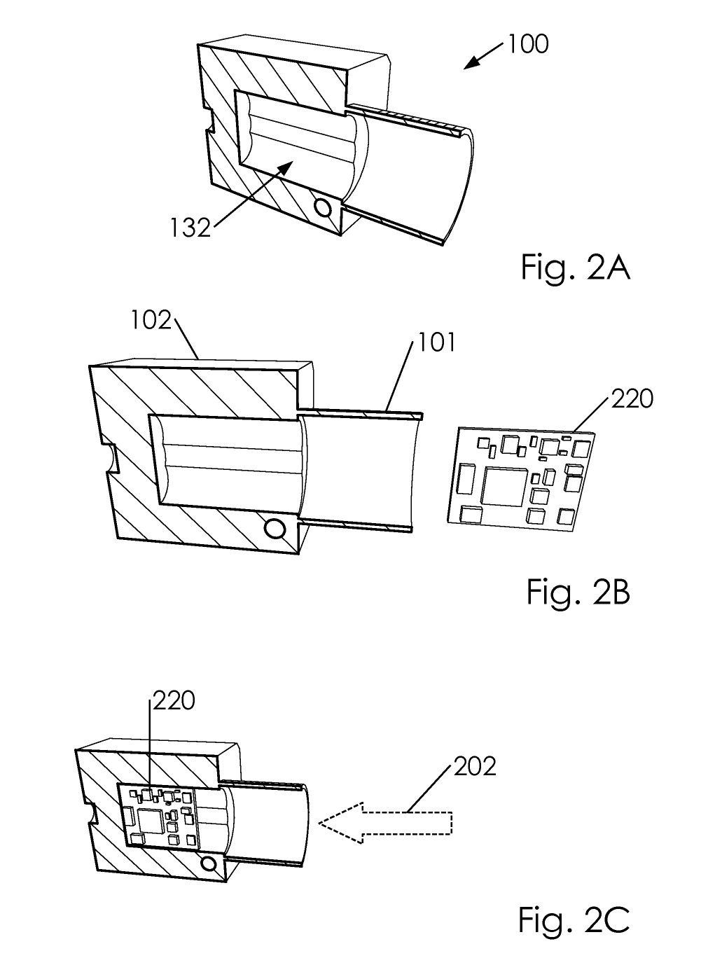

FIGS. 2A, 2B and 2C illustrate a perspective cross-section over view of said sensor system 100 without a logic board 220, with said logic board 220 outside of said cavity 132 and inside of said cavity 132. In one embodiment, said cavity 132 can be used to hold said logic board 220. In one embodiment, said body 102 can be used to protect said logic board 220 and mount it to said object for monitoring (as will be discussed below). In one embodiment, said sensor system 100 can comprise a logic board 220 comprising a plurality of components. In one embodiment, said logic board 220 can be attached to said body 102 with an adhesive, clip, tack or clip. In one embodiment, a one or more cables 202 can attach to said logic board 220 through said open end 134 of said NPT portion 101. In one embodiment, said logic board 220 can only be accessed through said NPT portion 101.

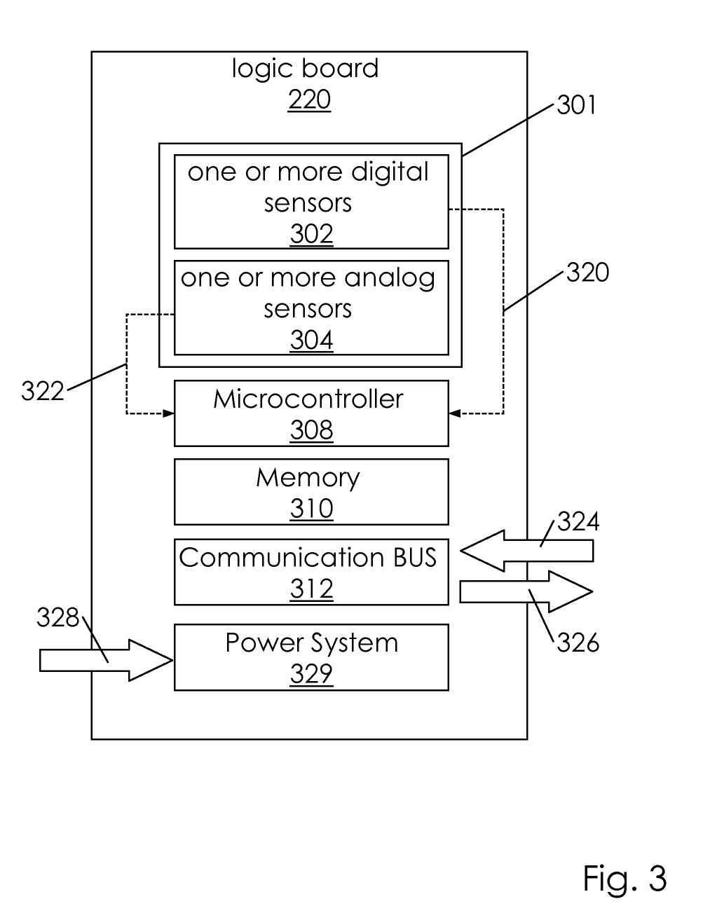

FIG. 3 illustrates a flow diagram of said plurality of components within said sensor system 100. In one embodiment, said sensor system 100 can comprise said logic board 220 having said plurality of components. In one embodiment, said plurality of components can comprise a one or more sensors 301. In one embodiment, said plurality of components can comprise a one or more digital sensors 302, a one or more analog sensors 304, a microcontroller 308, a memory 310, and a communication BUS 312. In one embodiment, said one or more sensors 301 can comprise said one or more digital sensors 302 and said one or more analog sensors 304. In one embodiment, said microcontroller 308 can comprise a microcontroller or microprocessor. In one embodiment, said microcontroller 308 can comprise a system on a chip capable of one or more well-known client/server tasks such as processing data inputs, communication over a network, data and/or web hosting. In one embodiment, said one or more digital sensors 302 can produce a one or more digital signals 320. In one embodiment, said one or more analog sensors 304 can produce a one or more analog signals 322. In one embodiment, said one or more sensors 301 can generate a one or more signals comprising said one or more digital signals 320 and said one or more analog signals 322. In one embodiment, said one or more analog signals 322 can be analyzed and converted into a digital signal by said microcontroller 308, or by an analog to digital converter before said one or more analog signals 322 reaches said microcontroller 308. In one embodiment, said communication BUS 312 can receive a data in 324 and send a data out 326. In one embodiment, said communication BUS 312 can comprise an industry standard BUS platform (such as CAN BUS) capable of communicating with industry standard sensors. In one embodiment, said communication BUS 312 can comprise a wireless networking capability (such as wifi, cellular 3G/4G, or similar). In one embodiment, said logic board 220 can receive a power input 328 at a power system 329. In one embodiment, said power system 329 can manage power distribution to said plurality of components of said logic board 220. In one embodiment, said logic board 220 can receive and send data to a client computer and/or a server. In one embodiment, said data in 324, said data out 326, and said power input 328 can comprise 4 wires (2 power and 2 data wires). In one embodiment, said one or more digital sensors 302 and/or said one or more analog sensors 304 can comprise three axis sensors (or tri-axial sensors). In one embodiment, said one or more digital sensors 302 and/or said one or more analog sensors 304 can comprise seismic, UTB, temperature, bearing condition, proximity, temperature (resistive thermal device or semiconductor temperature sensor), MEMS accelerometer (micro electro-mechanical systems accelerometer) and/or vibration sensors. In one embodiment, one or more different sensor types can be soldered onto said logic board 220 and can communicate over an industry standard BUS language (such as CAN BUS). In one embodiment, said one or more digital signals 320 of said one or more digital sensors 302 and said one or more analog signals 322 of said one or more analog sensors 304 can be referred to as one or more analog and digital signals.

In one embodiment, said microcontroller 308 is capable of processing said one or more analog and digital signals. In one embodiment, said one or more digital signals 320 of said one or more digital sensors 302 can be more accurate at low frequencies, and said one or more analog signals 322 of said one or more analog sensors 304 can be accurate at high frequencies; wherein, processing said one or more signals can comprise comparing said one or more digital signals 320 to said one or more analog signals 322, correcting for known inaccuracies in said one or more signals, and calculating a true signal.

In one embodiment, said one or more digital sensors 302 and said one or more analog sensors 304 can be capable of measuring and generating said one or more signals for an amplitude and vibration, a temperature, and a bearing condition status. In one embodiment, said microcontroller 308 can interpret said one or more digital signals 320 and digitize them for communication over a network (as discussed below). In one embodiment, said data out 326 can be communicated out of said sensor system 100 through said communications port 101. In one embodiment, generating said bearing condition status can comprise reading said one or more analog and digital signals, interpreting frequencies and frequency patterns (e.g., velocity, an acceleration or change in acceleration pattern) and matching said patterns to known bearing danger ranges and, in turn, signaling that one or more bearings are in a dangerous condition. In one embodiment, said frequency pattern can fall within a range of frequencies such as 1 KHz up to 5 KHz; or, for a motor, up to 30 Hz, and for many common machines 120 Hz. In one embodiment, said vibration sensor can comprise a tri-axial vibration monitoring system, and each axis can comprise an IPS (inches per second) rms and/or high pass g's pk.

In one embodiment, said sensor system 100 can comprise a signal amplification with integration and high frequency signal conditioning and filtering. In one embodiment, said sensor system 100 can comprise said microcontroller 308 with data acquisition. In one embodiment, said sensor system 100 can comprise a line driver integrated with a power supply. In one embodiment, said one or more sensors 301 can comprise a temperature sensor for temperature detection. In one embodiment, only a relatively low current (for example less than 100 mA) is required and thus a high number of said plurality of said sensor systems 100 can run off of a single power source. In one embodiment, each of said sensor systems 100 can comprise a unique identifier. In one embodiment, said unique identifier is added to said data out 326.

In one embodiment, said data out 326 can comprise a tri-axial overall vibration level in velocity ips or mm/sec. In one embodiment, data out 326 can comprise a bearing condition, such as high frequency g's pk measurement 1 KHz-5 KHz. In one embodiment, said data out 326 can comprise overall temperature measurement range (such as −40 degrees C. to 105 degrees C.) fixed. In one embodiment, said data out 326 can comprise all of the above.

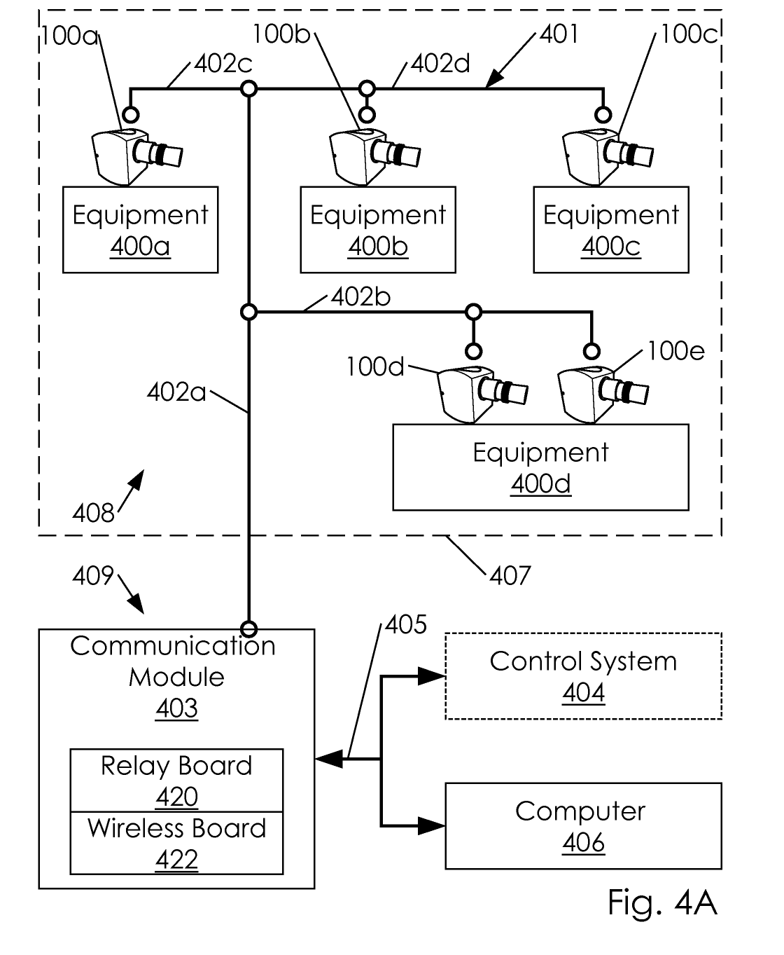

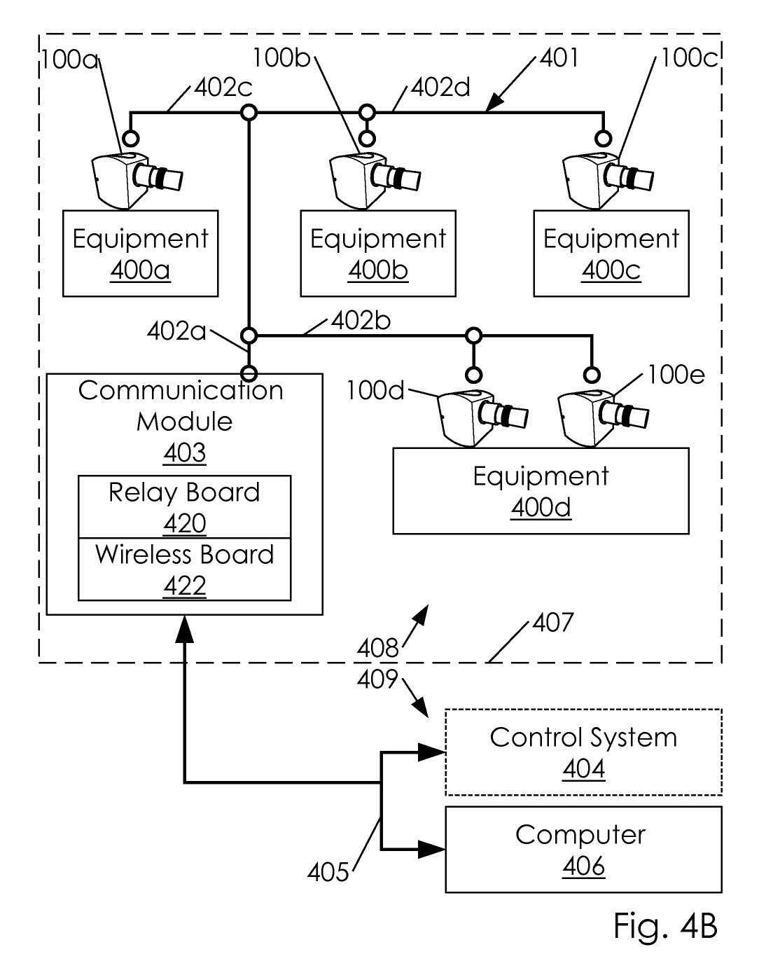

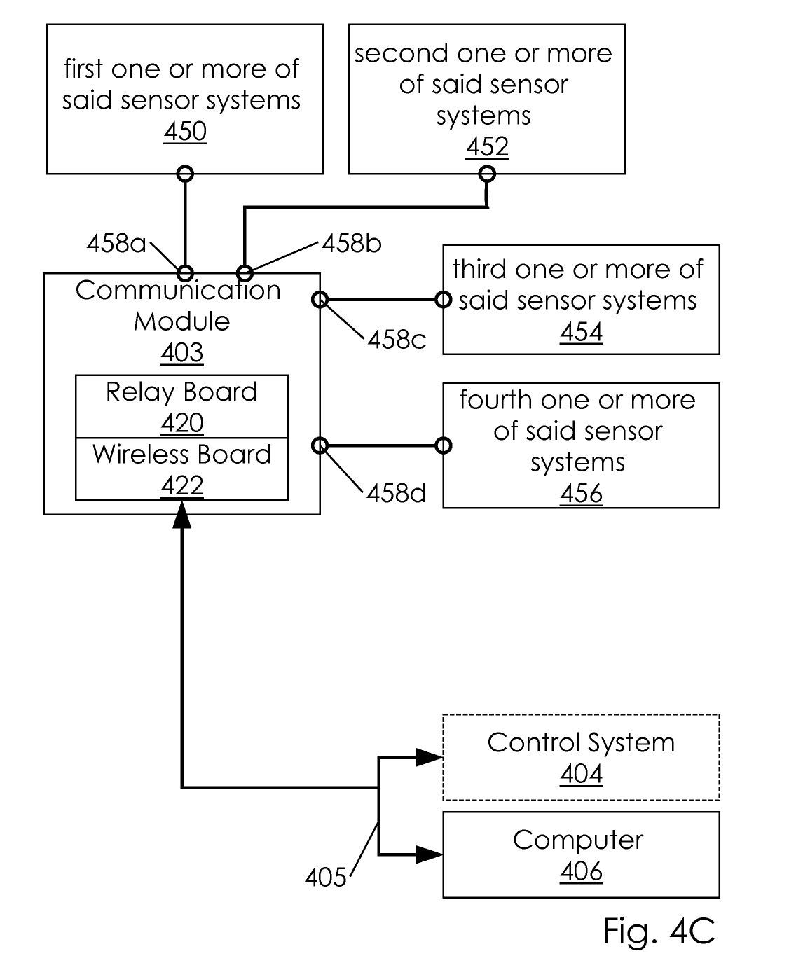

FIG. 4A illustrates a first network diagram of a plurality of said sensor systems 100. In one embodiment, said plurality of said sensor systems 100 can comprise a first sensor 100a, a second sensor 100b, a third sensor 100c, a fourth sensor 100d, a fifth sensor 100f and a sixth sensor 100e. In one embodiment, said plurality of said sensor systems 100 can be used to monitor a one or more equipment. In one embodiment, said one or more equipment can comprise a first equipment 400a, a second equipment 400b, a third equipment 400c and a multi-part equipment 400d. In one embodiment, said multi-part equipment 400d can comprise a multi-part machine requiring monitoring by one or more of said plurality of said sensor systems 100; thus, in one embodiment, said plurality of said sensor systems 100 can be capable of monitoring one or more equipment.

In one embodiment, each of sensor systems 100 can be attached to a network 401. In one embodiment, network 401 can comprise a daisy chain comprising a one or more data lines, each able to attach to sensor systems 100 without sending a separate one or more data lines for each of sensor systems 100 (that is in serial rather than parallel). In one embodiment, said one or more data lines can comprise network cable, USB cable, data bearing cable, or similar. In one embodiment, network 401 can comprise a branch circuit. In one embodiment, said one or more data lines can comprise a first line 402a, a second line 402b, a third line 402c and a fifth line 402d. In one embodiment, said sensor system 100 can reduce the number of mechanical connections by one-third or more, which reduces the points of possible failure, and reduces the cost and improves reliability of said sensor system 100 on said network 401.

In one embodiment, said one or more data lines can comprise a two-wire digital per axis (4 total) communication BUS; and thereby increases the immunity to EMI and RFI compared to other traditional transmitter or dynamic signal monitoring systems. Furthermore, for Zone 0 or Class 1 Division 1 hazardous area installations you will need just 1 common and relatively inexpensive intrinsic safety barrier to work with a large amount of sensors. More information yet less cost and less prone to problems.

In one embodiment, said network 401 can communicate with said sensor systems 100 and a communication module 403. In one embodiment, said communication module 403 can process said data out 326 from one or more of said plurality of said sensor systems 100. In one embodiment, said communication module 403 can communicate with a control system 404 over an external network 405. In one embodiment, said communication module 403 can communicate with a computer 406 over said external network 405. In one embodiment, said computer 406 can comprise a client or a server computer located on an intranet or through an internet with said communication module 403. In one embodiment, said communication module 403 can comprise a relay board 420 and/or a wireless board 422. In one embodiment, said wireless board 422 can comprise a wireless networking capability (such as wifi, cellular 3G/4G, or similar). In one embodiment, said wireless board 422 can communicate with said plurality of said sensor systems 100 by wireless transmission rather than through said one or more data lines. In one embodiment, said communication module 403 can function as a controller with said plurality of said sensor systems 100 and thereby replace said control system 404. In one embodiment, said communication module 403 and/or said control system 404 can receive said data out 326 from said plurality of said sensor systems 100 and therewith calculate new functions for said plurality of said sensor systems 100, said one or more equipment, and/or one or more other systems (as is well-known in the art). Thus, in one embodiment said communication module 403 can function as a node (facilitating communication between said plurality of said sensor systems 100) in said network 401 and/or a computer controller (facilitating and

In one embodiment, said relay board 420 and/or said wireless board 422 can be integrated into said communication module 403. In another embodiment, said relay board 420 and/or said wireless board 422 can be added to said communication module 403 by plugging in said relay board 420 and/or said wireless board 422 into said communication module 403. In one embodiment, said relay board 420 and/or said wireless board 422 can comprise an off the shelf, well-known industry expansion board.

In one embodiment, said network 401 can span a firewall 407; wherein, said firewall 407 can comprise an inside 408 and an outside 409. In one embodiment, said inside 408 of said firewall 407 can comprise a space within firewall 407 where one or more equipment and multi-part equipment 400d are operating. In one embodiment, said inside 408 can comprise a specified “class 1, div 2” area. In one embodiment, said inside 408 can comprise a hazardous gas area which must be kept isolated. In one embodiment, said inside 408 of said firewall 407 can comprise a “class 1, div 1” area.

In one embodiment, said outside 409 can comprise an area outside of firewall 407. In one embodiment, said communication module 403 can be located said outside 409 of said firewall 407. In one embodiment, said network 401 can require only one of one or more data lines to span both side of said firewall 407. In one embodiment, said network 401 can deliver power to said plurality of said sensor systems 100. In one embodiment, by only bringing one or more of said one or more data lines through said firewall 407, general safety has increased because: there is no need to run multiple wires through firewall 407, no need to walk around firewall 407 by staff, only one firewall 407 is required, and because the amount of input/output (“I/O”) through network 401 is minimized.

In one embodiment, said one or more equipment can comprise a blower, centrifuge, compressor, pump, turbine, cooling tower, gear box, engine, fan, generator, and/or motor.

In one embodiment, said plurality of said sensor systems 100 can be made of high quality materials and to thresholds capable of work environments. In one embodiment, said plurality of said sensor systems 100 can withstand extremes temperatures, corrosive chemicals, lubricating oil, humidity, moisture, grease, physical abuse, and the like. Likewise, use of said sensor system 100 can help one or more equipment to last as long as possible and so said sensor systems 100 are designed to surpass the life expectation of one or more equipment which they are monitoring.

In one embodiment, sensor systems 100 can connect via Modus RTU to a PLC, SCADA or DCS and provide protection to all types of said one or more equipment.

In one embodiment, said communication module 403 can be removed and said network 401 can be attached directly to said control system 404 or said computer 406, each of which is capable of monitoring and controlling said sensor systems 100, and said one or more equipment.

In one embodiment, each of said plurality of said sensor systems 100 can comprise a monitoring system capable of monitoring three (or more) fundamental parameters of one or more equipment and multi-part equipment 400d; viz., three axial overall vibration, bearing/gear condition, and temperature. Since all three functions can be put into each of said one or more equipment, and because it can be configured to only require wiring to the nearest among said sensor system 100 across said network 401, less than one third of said one or more data lines can be required for said network 401 comprising said plurality of said sensor systems 100.

There are several ways to use said sensor system 100 on said network 401. In one embodiment, said sensor systems 100 can be used with an existing PLC, DCS or SCADA system; wherein, said data out 326 of said logic board 220 (comprising a portion of or a filtered version of said one or more digital signals 320 and/or said one or more analog signals 322) can be sent to said communication module 403, said control system 404 and/or said computer 406. In one embodiment, said data out 326 can be communicated via a Modbus RTU (standard) or other communication protocols. In one embodiment, said network 401 can no longer require a plurality of expensive 4-20 mA loops and analog 4-20 mA I/O modules. In one embodiment, PLC, DCS or SCADA systems may then be programmed to alarm the operator of a significant change in a machines' condition or you may also program the control system to shutdown the machine on a high parameter level.

In one embodiment, said computer 406 can comprise a stand-alone PC or laptop; in this scenario a system user (such as a plant maintenance personnel) could view conditions of said one or more equipment from a remote computer using a software on said computer 406; wherein, said system user may view an overall vibration levels, a temperatures and a bearing or gear conditions of said one or more equipment at near real-time speed.

In one embodiment, frequency response range from 3 Hz-3 KHz (overall) and 1 KHz-10 KHz (−3 dB) bearing condition. In one embodiment, axis orientation can comprise a tri axial measurement. In one embodiment, sensor systems 100 can comprise one or more certifications as will be necessary in different jurisdictions and for different purposes, such as general purpose use (or CE), Class 1 Div 2 Group A-D (or CSA) and/or intrinsically safe for use with a barrier (or “IECEx Intrinsically Safe”). In one embodiment, sensor systems 100 can comprise an isolation specification of 500 Vrms, circuit to case. In one embodiment, sensor systems 100 can comprise an environmental rating of IP67 and/or NEMA 4. In one embodiment, sensor systems 100 can comprise an enclosure material of 416 SS. In one embodiment, sensor systems 100 can comprise an accuracy of plus or minus five percent. In one embodiment, sensor systems 100 can comprise a maximum transmission distance of 500 meters. In one embodiment, sensor systems 100 can comprise a maximum number of devices per loop of 500 units. In one embodiment, sensor systems 100 can comprise a polling internal time per unit of 500 msec/device. In one embodiment, sensor systems 100 can comprise a mounting requirement of ⅜-24 mounting stud or M8X1. In one embodiment, sensor systems 100 can comprise a field wiring connection of 4 pin connectors. In one embodiment, sensor systems 100 can comprise a power requirement of 5 VDC at greater than 100 mA line power. In one embodiment, sensor systems 100 can comprise a weight of 0.1 pounds. In one embodiment, sensor systems 100 can comprise one of a plurality of outputs such as a 4 pin terminal block with rubber boot or a 4 pin Mil connector. In one embodiment, sensor systems 100 can comprise a range for overall vibration output including: 55=0.5 ips (peak), 01=1.0 ips (peak), 02=2.0 ips (peak), 05=12.7 mm/s (rms), 10=25.4 mm/s (rms), and/or 50=50.0 mm/s (rms). In one embodiment, each of sensor systems 100 can comprise a set of instructions and/or configuration software. In one embodiment, said configuration software can further comprise a real time table view of said data out 326 as returned by one or more sensor systems 100.

FIG. 4B illustrates a second network diagram of said plurality of said sensor systems 100. In one embodiment, said communication module 403 can be located within said inside 408 of said firewall 407. In one embodiment, a portion of said external network 405 can span firewall 407.

FIG. 4C illustrates a third network diagram of said plurality of said sensor systems 100. In one embodiment, said communication module 403 can comprise a one or more nodes capable of communicating with a one or more sensor groups (each composed of one or more of said plurality of said sensor systems 100). In one embodiment, said one or more sensor groups can comprise a first one or more of said sensor system 450, a second one or more of said sensor system 452, a third one or more of said sensor system 454 and a fourth one or more of said sensor system 456. In one embodiment, said one or more nodes of said communication module 403 can comprise a first node 458a, a second node 458b, a third node 458c and a fourth node 458d. In one embodiment, each of said one or more nodes can communicate with up to 50 of said sensor system 100. In one embodiment, a speed of each one or more nodes can be considered when arranging said plurality of said sensor systems 100 as connected to said communication module 403. In one embodiment, a distance from said communication module 403 can be considered while arranging said plurality of said sensor systems 100 as upon said one or more nodes.

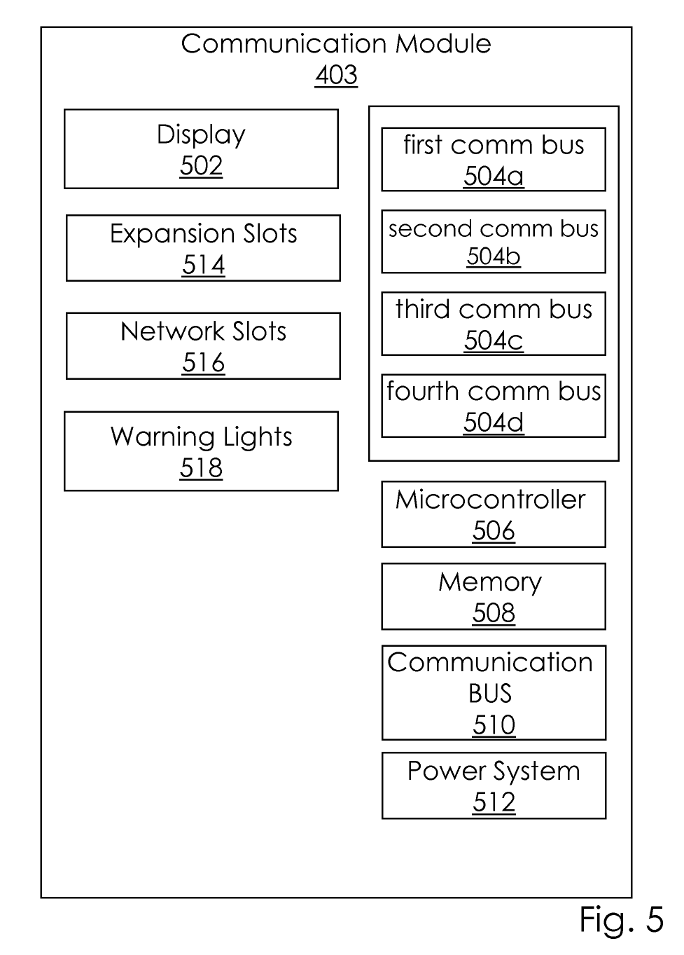

FIG. 5 illustrates a flow diagram of said plurality of components within said communication module 403. In one embodiment, said communication module 403 can comprise an display 502, a one or more communication buss (comprising a first communication bus 504a, a second communication bus 504b, a third communication bus 504c and a fourth communication bus 504d), a microcontroller 506, a memory 508, a communication bus 510, a power system 512, a one or more expansion slots 514, a network slot 516, and a one or more warning lights 518. In one embodiment, said one or more communication buss can communicate with said one or more nodes. For example, in one embodiment, said first communication bus 504a can communicate with said first node 458a, said second communication bus 504b with said second node 458b, said third communication bus 504c with said third node 458c, and said fourth communication bus 504d with said fourth node 458d. In one embodiment, said microcontroller 506 can process data from said one or more communication buss, execute programmed code, interact with devices attached to said one or more expansion slots 514 or said network slot 516, process and provide information to said 502/, store an access in said memory 508, communicate across said communication bus 510, manage a power scheme for said power system 512. In one embodiment, said communication bus 510 in combination with said network slot 516 and/or said one or more expansion slots 514 can communicate data into and out of said communication module 403. In one embodiment, said one or more expansion slots 514 can receive a wireless expansion card capable of adding a wifi, cellular or similar wireless communication protocol to said communication module 403. In one embodiment, said power system 512 can manage said power scheme for said communication module 403. In one embodiment, said power scheme can manage a power output to said plurality of said sensor systems 100 from said one or more communication buss. In one embodiment, said one or more warning lights 518 and said display 502 can be provide for human-machine interaction. In one embodiment, said power system 512 can receive an input of 10v-36v. In one embodiment, said one or more expansion slots 514 can receive said relay board 420 and/or said wireless board 422 with capabilities described above and known in the art. In one embodiment, said one or more expansion slots 514 can comprise one or more USB slots or a single USB slot capable of expansion with a USB hub (as is known in the art). In one embodiment, said network slot 516 can comprise a one or more standard Ethernet ports for communication on a standard computer network (or similar). In one embodiment, said microcontroller 506 can be used to prioritize said plurality of said sensor systems 100 through said one or more communication buss in order to focus resources to said one or more equipment needing extra attention, or to allocate resources to problems in said network 401. In one embodiment, said one or more communication buss can comprise four or more nodes. In one embodiment, each of said one or more communication buss can be independent of the others. In one embodiment, said one or more nodes on said one or more communication buss can run at CAN BUS speeds and on the same protocol. In one embodiment, said one or more communication buss can comprise DB9, DV9, Ethernet, and/or pluggable screw terminals connector types for receiving said one or more nodes.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An industrial sensor system comprising:
a communication module;
a one or more sensors having a body and a logic board;
a one or more signals generated by said logic boards of said one or more sensors;
said logic board of said one or more sensors having
a microcontroller capable of processing said one or more signals and
a communication BUS capable of communicating with said communication module and other among said one or more sensors over a network;
a power system;
said one or more sensors comprise triaxial sensors;
said one or more sensors comprise a one or more seismic sensors capable of generating a one or more seismic signals, and said one or more signals comprise said seismic signals
said one or more sensors comprise a one or more digital sensors generating a one or more digital signals and a one or more analog sensors generating a one or more analog signals;
processing said one or more signals with said microcontroller comprises
comparing said one or more digital signals to said one or more analog signals,
favoring said one or more digital signals at a low frequencies and said one or more analog signals at a high frequencies, and
calculating a true signal.

2. The industrial sensor system of claim 1 wherein, said one or more sensors comprise a one or more pressure sensors capable of generating a one or more pressure signals, and said one or more signals comprise said one or more pressure signals.

3. The industrial sensor system of claim 1 wherein, said one or more sensors comprise a one or more temperature sensors capable of generating a one or more temperature signals, and said one or more signals comprise said temperature signals.

4. The industrial sensor system of claim 1 wherein, said logic board of said one or more sensors comprise a memory.

5. The industrial sensor system of claim 1 wherein, said low frequencies comprise a rate below 2 Hz.

6. The industrial sensor system of claim 1 wherein, said high frequencies comprise a rate above 5 Hz.

7. The industrial sensor system of claim 1 further comprising calibrating said one or more digital signals to said one or more analog signals at mid frequencies between said high frequencies and said low frequencies.

8. The industrial sensor system of claim 1 wherein,
said communication module comprises a one or more communication buss capable of communicating with one or more sensor groups in a one or more nodes; and
said one or more sensor groups each comprise a one or more of said sensor system.

9. The industrial sensor system of claim 8 wherein, said one or more communication buss and said one or more nodes comprise CAN BUS.

10. The industrial sensor system of claim 1 wherein,
said communication module is capable of controlling a one or more of said sensor system.

11. The industrial sensor system of claim 1 wherein,
said communication module comprises a microcontroller capable of processing said one or more signals of said one or more of said sensor system.

12. The industrial sensor system of claim 1 wherein,
said communication module comprises a microcontroller capable of processing said one or more signals of said one or more of said sensor system, and
controlling a one or more equipment based on an outcome of said processing of said one or more signals of said one or more of said sensor system.

13. The industrial sensor system of claim 1 wherein, said network comprises a plurality of said communication module attached to a plurality of said sensor system.

14. The industrial sensor system of claim 1 further comprising,
a computer attached to a one or more communication module through an external network; and
said computer is capable of monitoring and controlling said communication module and said one or more sensor systems.

15. The industrial sensor system of claim 1 wherein,
said one or more sensors comprise a one or more proximity sensors capable of generating a one or more proximity signals, and
said one or more signals comprise said one or more proximity signals.

16. The industrial sensor system of claim 15 wherein,
said one or more proximity sensors comprise a two non-contact proximity sensor inputs; and
said sensor system comprises an oscillator demodulator.

17. The industrial sensor system of claim 16 further comprising
said two non-contact proximity sensor inputs attach to a two proximity sensors;
said two proximity sensors attach to a one or more equipment at 90 degree radial separation; and
said two proximity sensors are capable of measuring radial vibration measurements.

18. The industrial sensor system of claim 16 further comprising
said two non-contact proximity sensor inputs attach to a two proximity sensors;
said two proximity sensors are mounted on an axial end of a shaft; and
said two proximity sensors are capable of thrust bearing monitoring.

19. The industrial sensor system of claim 16 further comprising calibrating said proximity sensors by linearizing said two proximity sensors.

20. The industrial sensor system of claim 16 further comprising finding a minimum path point and a maximum path point with said two proximity sensors for elliptical vibration orbit of equipment.
